(19) United States
(12) Patent Application Publication
(10) Pub. No.: US 2012/0055458 A1
(43) Pub. Date: Mar. 8, 2012

(54) CUTTING DEVICE WITH A LIQUID LEVEL DISPLAY

(75) Inventor: Chih-Ming CHENG, Taichung (TW)

(73) Assignee: REXON INDUSTRIAL CORP., LTD., Taichung (TW)

(21) Appl. No.: 13/218,690

(22) Filed: Aug. 26, 2011

(30) Foreign Application Priority Data
Sep. 3, 2010 (TW) 099129870

(51) Int. Cl. B28D 7/02

(52) U.S. Cl. 125/12

(57) ABSTRACT

A cutting device includes an accommodation chamber having a through hole, a cover plate covering the accommodation chamber, and a cutting unit carrying a cutting element that is partially submerged in a cooling fluid in the accommodation chamber. A liquid level display is provided in fluid communication with the through hole in the accommodation chamber for indicating the level of the cooling fluid so that a user can conveniently ascertain in real time, from outside the cutting device, the current amount of the cooling fluid retained within the accommodation chamber and can add cooling fluid to the accommodation chamber as needed in real time, thus achieving improved performance in cooling and lubricating the cutting element.

This application claims, under 35 U.S.C. §119, priority to Taiwanese Application No. 099129870, filed Sep. 3, 2010, which application is hereby incorporated by reference in its entirety, inclusive of the specification, claims, and drawings.

### FIELD OF THE INVENTION

The present disclosure relates to a cutting device and more particularly, to a cutting device with a liquid level display.

### BACKGROUND

To avoid overheating and subsequent damage to a cutting element (blade) during cutting of tile using a tile cutter and in order to facilitate smooth cutting, water is used to cool down the cutting element and to provide a lubricating effect. U.S. Pat. No. 6,439,218 discloses the use of a pump assembly with a pump and tube for moving a liquid from a pan and onto the cutting element to lower the temperature thereof and to provide a lubricating effect.

With the exception of spray cooling type tile cutters, many tile cutters require the cutting element to be maintained at least in partial contact with (partially submerged below) the water level of water retained in a sink (container). For example, U.S. Pat. No. 7,028,683, Taiwan Patent No. M316117, Chinese Patent No. CN200948649Y, Chinese Patent No. CN200963878Y, and Chinese Patent No. CN1013183555Y commonly describe allowing the bottom side of the cutting element to be dipped/partially submerged in water in a water container for cooling and lubricating the cutting element.

As stated above, conventional tile cutters commonly have a water chamber (sink) for holding water. By means of spraying water onto the cutting element or dipping (submerging) a part of the cutting element in the water retained in the water chamber, the cutting element is cooled down and lubricated. However, the cited prior art designs do not well control the amount of water in the water chamber. They also do not allow the user to ascertain the amount of water in the water chamber in real time. Therefore, conventional tile cutters may be unable to effectively cool down and lubricate the cutting element, or may be unable to perform a cooling and lubricating operation.

Therefore, it is desirable to provide a cutting device capable of cutting tile, which enables the user to ascertain the current amount of water inside the machine in real time.

### SUMMARY

The present disclosure has been accomplished under the circumstances in view. The present disclosure describes a cutting device, for example a tile cutter, which is equipped with a liquid level display to indicate the current level of the cooling fluid in the accommodation chamber thereof.

According to embodiments of the present disclosure, a cutting device includes an accommodation chamber, a cover plate, a cutting unit and a liquid level display. The accommodation chamber has a bottom wall, an upright peripheral wall upwardly extending from the bottom wall at a border thereof and a through hole passing through the upright peripheral wall. The cover plate covers the accommodation chamber. The cutting unit includes a cutting element disposed in the accommodation chamber at a top side thereof. The liquid level display is connected to the through hole and adapted for indicating the level of the cooling fluid in the accommodation chamber.

Thus, the cooling fluid flows through the through hole into the liquid level display so that the level of the cooling fluid in the liquid level display is representative of the level of the cooling fluid in the accommodation chamber. Therefore, the user can conveniently ascertain in real time, from the outside of the cutting device, the current amount of the cooling fluid in the accommodation chamber.

### BRIEF DESCRIPTION OF THE DRAWINGS

FIG. 1 is an elevational view of a cutting device with a liquid level display in accordance with a first embodiment of the present disclosure.

FIG. 2 is a sectional view of the first embodiment of the present disclosure, illustrating the positioning of the liquid level display relative to the accommodation chamber of the cutting device.

FIG. 3 is an elevational view, illustrating the structure of the liquid level display of the cutting device in accordance with the first embodiment of the present disclosure.

FIG. 4 is a perspective view of the cutting device in accordance with the first embodiment of the present disclosure, illustrating the arrangement of the through hole and flange of the accommodation chamber of the cutting device.

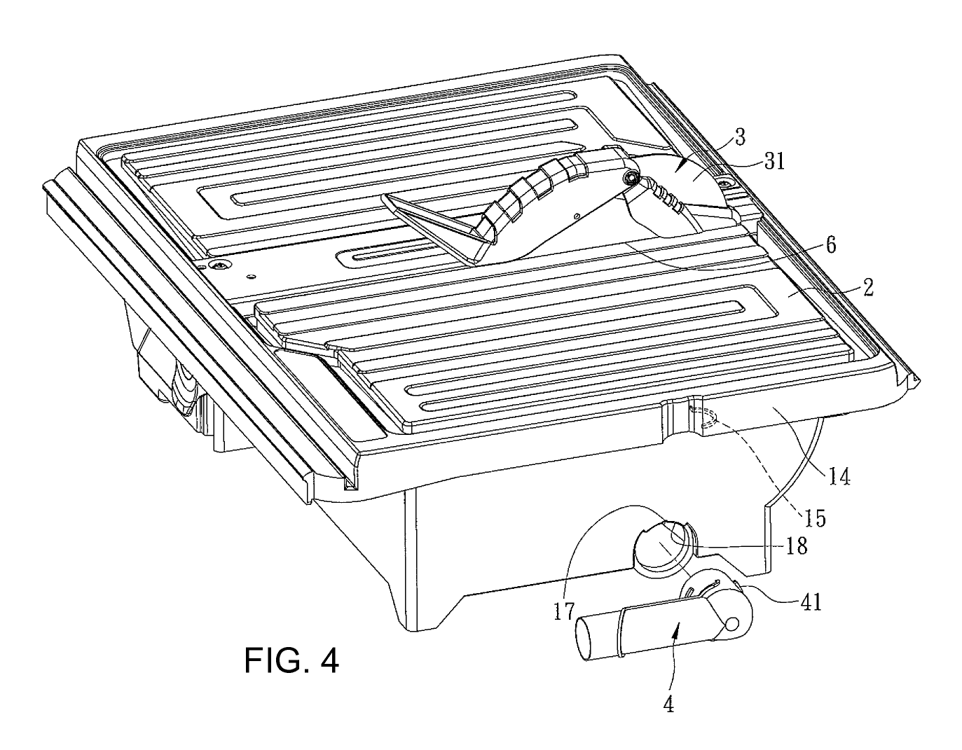

FIG. 5 is a partial sectional view of the cutting device in accordance with the first embodiment of the present disclosure, illustrating the arrangement of the groove and retaining crevice of the accommodation chamber cutting device.

FIG. 6 is a bottom view of the cutting device in accordance with the first embodiment of the present disclosure, illustrating the arrangement of the rim of the accommodation chamber of the cutting device.

FIG. 7 is a perspective view of a part of a cutting device with a liquid level display in accordance with a second embodiment of the present disclosure.

### DETAILED DESCRIPTION

Other and further advantages and features of the present disclosure will be understood by reference to the following specification in conjunction with the accompanying drawings, in which like reference signs denote like elements of structure.

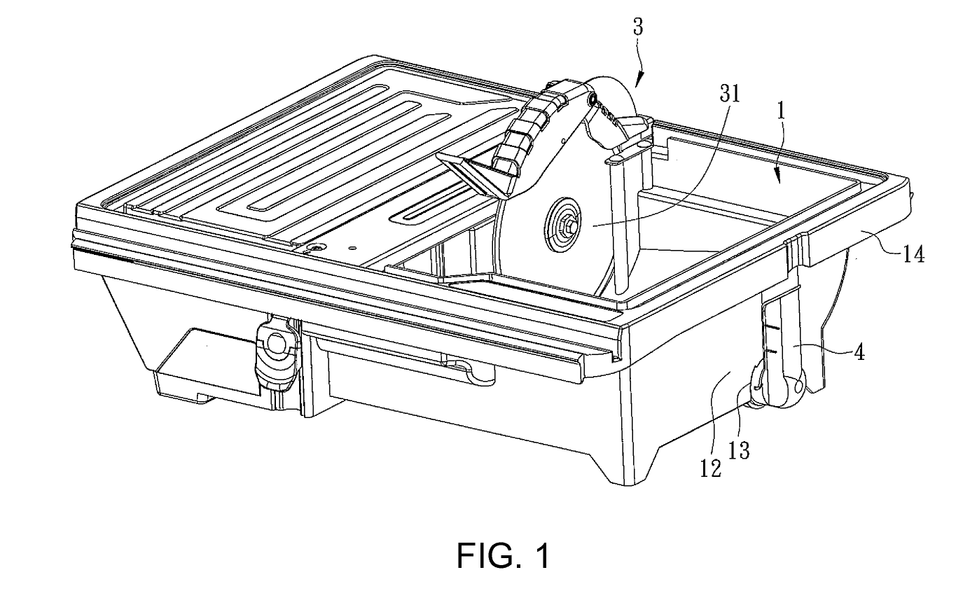

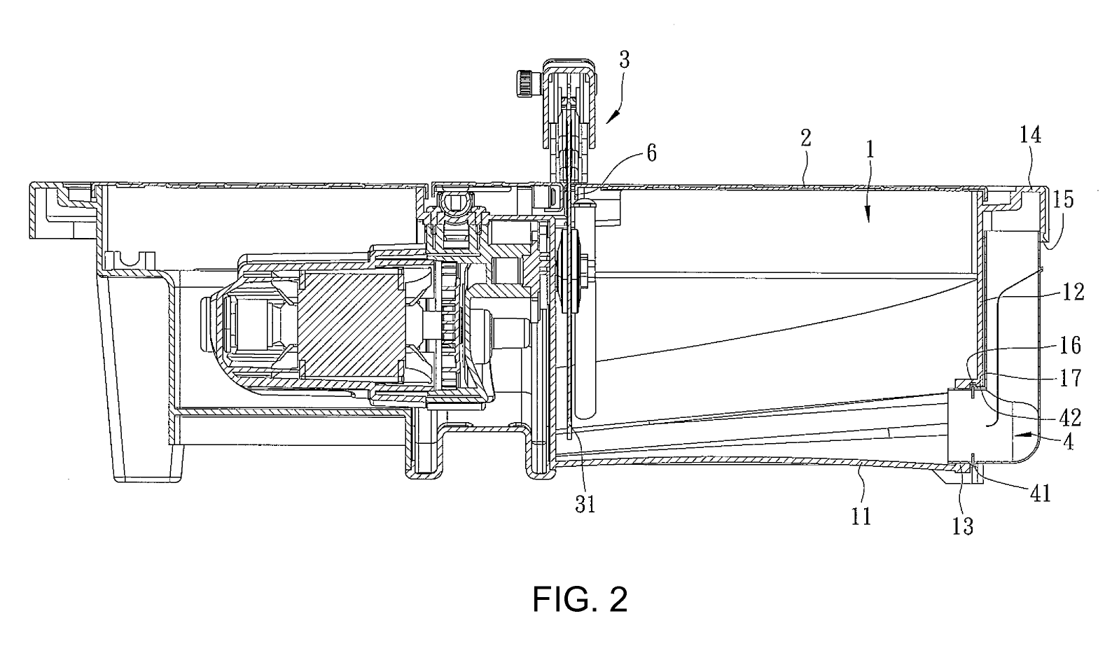

Referring to FIGS. 1 and 2, a cutting device with a liquid level display in accordance with a first embodiment of the present disclosure is shown. The cutting device includes an accommodation chamber 1, a cover plate 2, a cutting unit 3, and a liquid level display 4.

The accommodation chamber 1 is adapted for holding a cooling fluid, for example, water. The accommodation chamber 1 is defined by a bottom wall 11 and an upright peripheral wall 12 extending upwardly from the border of the bottom wall 11. A rim 14 extends around the topmost edge of the upright peripheral wall 12 and a stop flange 15 is downwardly extended from the rim 14. A through hole 13 is disposed adjacent to the bottom wall 11 and passes through the upright peripheral wall 12. The bottom wall 11 slopes downwardly in direction toward the through hole 13, facilitating flowing of the cooling fluid toward the through hole 13 during use of the cutting device.

As shown in FIG. 2, the cover plate 2 covers the accommodation chamber 1, and is used as a worktable for holding the workpiece during cutting thereof. After lifting and removal of the cover plate 2 from the accommodation chamber 1, cleaning of the accommodation chamber 1 can be performed.

The cutting unit 3 includes a cutting element 31 disposed in the top side of the accommodation chamber 1 and partially submerged in the cooling fluid inside the accommodation chamber 1. The cooling fluid that is held in the accommodation chamber 1 is adapted for lowering the temperature of the cutting element 31, carrying dust away from the cutting element 31, and providing a lubrication effect.

Further, it is to be understood that the bottom wall 11 of the accommodation chamber 1 slopes downwardly along the axial direction of the cutting element 31 so that the cooling fluid flows along the bottom wall 11 from the cutting element 31 toward the through hole 13. Further, the bottom wall 11 of the accommodation chamber 1 rises gradually in the radial direction from the lowest point corresponding to the center point of the cutting element 31 toward the border area, i.e., the accommodation chamber 1 shows a stepped profile relative to the cutting element 31 so that a minimum amount of cooling fluid can carry out maximum effects of cooling, dust removal, and lubrication.

Further, for modular use with different cutting device models, for example, a model in which the cooling fluid is to be sprayed onto the cutting element 31, the cutting element 31 can be disposed above the accommodation chamber 1 without being partially submerged in the cooling fluid.

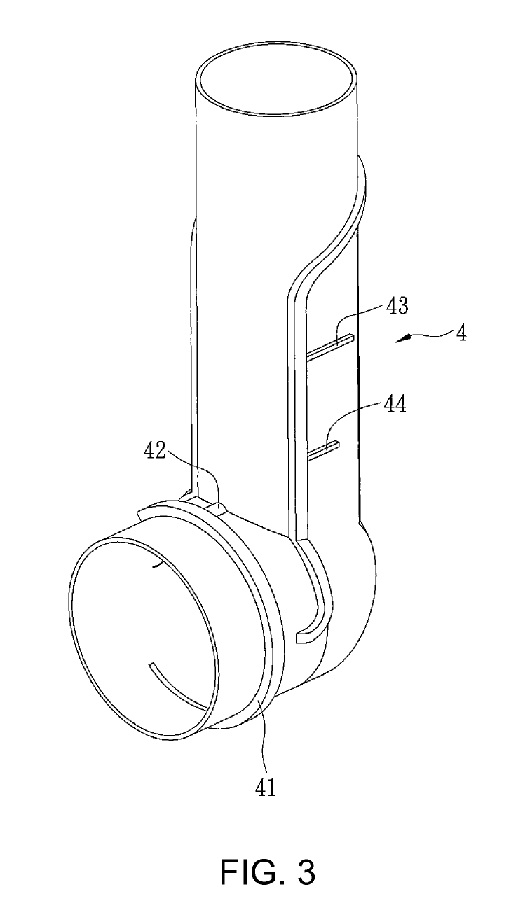

Referring to FIGS. 1, 2, and 3, the liquid level display 4 is connected to the through hole 13. According to this embodiment, the liquid level display 4 is an L-shaped tube, which is open at both ends. Because the atmospheric pressure in the accommodation chamber 1 and the atmospheric pressure in the liquid level display 4 are equal, the liquid level display 4 can be used to indicate the level of the cooling fluid in the accommodation chamber 1. Further, the liquid level display 4 is disposed underneath the bottom side of the rim 14 in order to prohibit cutting dust from falling into the upper open end of the liquid level display 4 during a cutting operation. Further, in addition to facilitating, conveniently from the outside, an indication of the current amount of the cooling fluid in the accommodation chamber 1, the through hole 13 can be used for adding a cooling fluid to fill the accommodation chamber 1 or guiding the stored cooling fluid out of the accommodation chamber 1 to lower the level of the cooling fluid in the accommodation chamber 1 or to empty the accommodation chamber 1.

To facilitate mounting and dismounting of the liquid level display 4 to and from the through hole 13, the liquid level display 4 is formed with a C-shaped flange 41, extending around and protruding from the periphery of the lower open end of the liquid level display 4, and a retaining rib 42. Further, the liquid level display 4 includes a high-level marking line 43 and a low-level marking line 44.

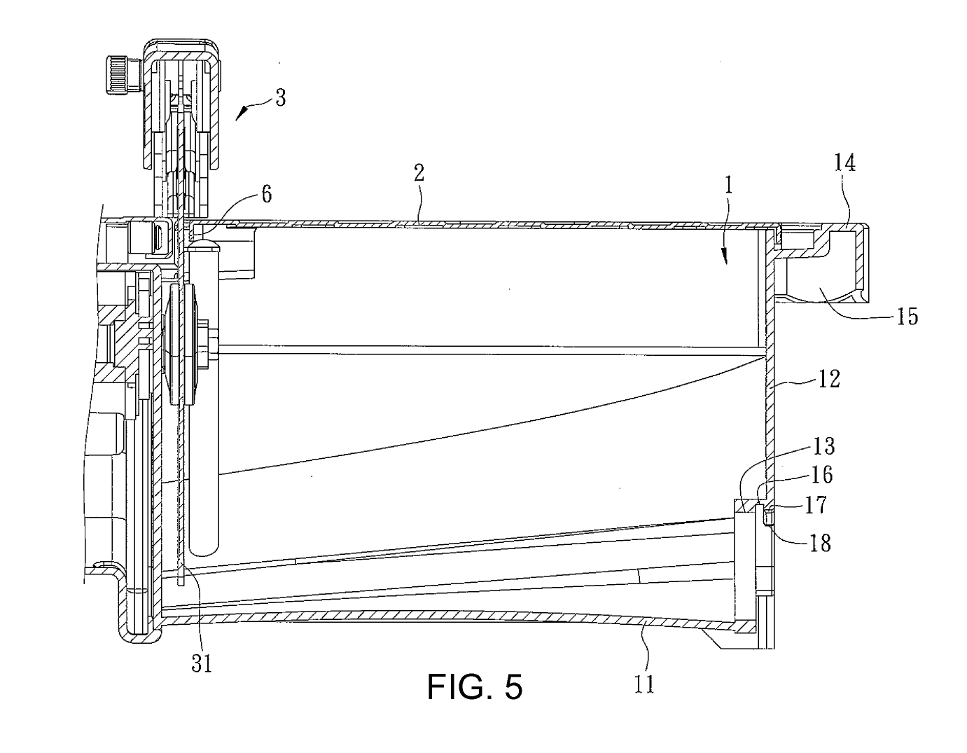

Referring to FIGS. 1, 2, and 5, the accommodation chamber 1 has a groove 16 formed adjacent to and around the through hole 13 in the upright peripheral wall 12. The groove 16 corresponds to the C-shaped flange 41 of the liquid level display 4. A flange 18, corresponding to the gap between the two opposed distal ends defining the C-shaped flange 41, is positioned adjacent to the groove 16, and a retaining crevice 17, corresponding to and cooperating with the retaining rib 42, is positioned next to the flange 18 to provide a snap fit retention of the liquid level display 4.

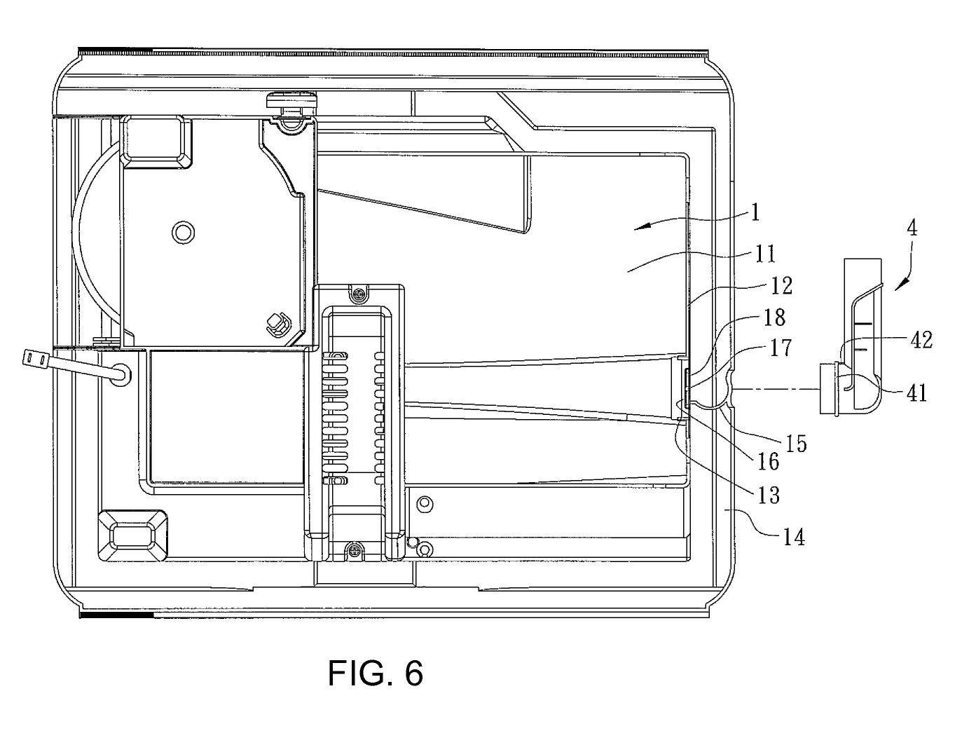

Referring to next to FIGS. 2 and 6, during installation of the liquid level display 4, the liquid level display 4 is first maintained horizontally orientated, and then the lower open end of the liquid level display 4 is orientated such that the gap between the two distal ends of the C-shaped flange 41 is aligned with the flange 18. The lower open end of the liquid level display 4 is then inserted into the through hole 13 to align the C-shaped flange 41 with the groove 16. The liquid level display 4 is then rotated through 90-degrees from the horizontal position to a vertical position to engage the retaining rib 42 with the retaining crevice 17, and to engage the top open side of the liquid level display 4 against the stop flange 15 underneath the bottom side of the rim 14.

In order to remove the liquid level display 4, the liquid level display 4 is rotated in the opposite direction from the vertical position to the horizontal position, and then the liquid level display 4 is pulled outwards from the through hole 13. After removal of the liquid level display 4 from the through hole 13, the cooling fluid can be drained out of the accommodation chamber 1 through the through hole 13, or additional cooling fluid can be added to the accommodation chamber via the through hole 13.

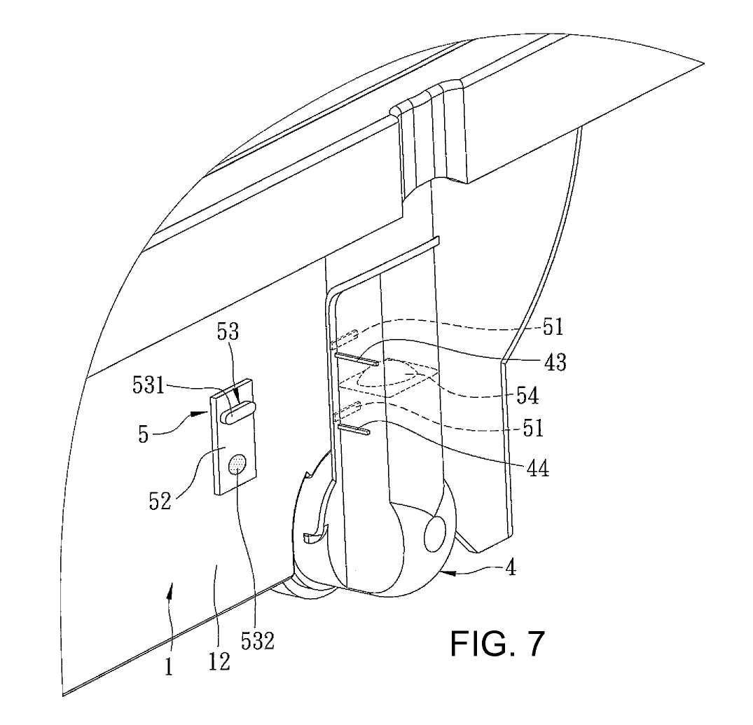

FIG. 7 illustrates a cutting device with a liquid level display in accordance with a second embodiment of the present disclosure. This second embodiment is substantially similar to the aforesaid first embodiment with the exception that this second embodiment further includes a sensor and alarm unit 5. The sensor and alarm unit 5 comprises two sensors 51 respectively installed in the liquid level display 4 corresponding to the high-level marking line 43 and the low-level marking line 44, a control device 52 electrically connected to the sensors 51 and the cutting unit 3 (as indicated in FIG. 1), and an audio visual alarm 53 electrically connected to the control device 52.

The sensors 51 are adapted for sensing the fluid level in the liquid level display 4. A supplementary ball-float 54 may also be used to assist sensing. When the fluid level in the liquid level display 4 is excessively high or excessively low, the corresponding sensor 51 outputs a signal to the control device 52, causing the control device 52 to shut down the cutting unit 3, avoiding improper operation and/or overheating due to too much or insufficient cooling fluid. At the same time, the control device 52 drives the audio visual alarm 53 to give off a warning signal. According to this second embodiment, the audio visual alarm 53 includes a warning light 531 and a warning buzzer 532.

In conclusion, by installing the liquid level display 4 in the through hole 13, embodiments of the disclosure allow the user to conveniently ascertain in real time, from outside the cutting device, the current amount of the cooling fluid in the accommodation chamber 1. If the amount of the cooling fluid in the accommodation chamber 1 is insufficient, the user can add additional cooling fluid to the accommodation chamber 1 in real time, achieving improved performance in cooling and lubricating the cutting element 31. Further, the liquid level display 4 is disposed underneath the bottom side of the rim 14, which prohibits cutting dust from falling into the inside of the liquid level display 4 during a cutting operation.

Although particular embodiments of the disclosure have been described in detail for purposes of illustration, various modifications and enhancements may be made without departing from the spirit and scope of the disclosure. Accordingly, the disclosure is not to be limited except as by the appended claims.

What is claimed is:

1. A cutting device, comprising:
an accommodation chamber adapted for holding a cooling fluid, said accommodation chamber comprising a bottom wall, an upright peripheral wall upwardly extending from the bottom wall at a border thereof and a through hole passing through said upright peripheral wall;
a cover plate covering said accommodation chamber;
a cutting unit comprising a cutting element disposed in a top side relative to said accommodation chamber; and
a liquid level display connected to said through hole and adapted for indicating the level of the cooling fluid in said accommodation chamber.

2. The cutting device as claimed in claim 1, wherein said liquid level display is an L-shaped tube.

3. The cutting device as claimed in claim 1, wherein said liquid level display is detachably mounted in said through hole.

4. The cutting device as claimed in claim 3, wherein said liquid level display comprises a C-shaped flange protruding from and extending around the periphery thereof and a retaining rib; said accommodation chamber comprises a groove corresponding to the C-shaped flange of said liquid level display and a retaining crevice corresponding to the retaining rib of said liquid level display.

5. The cutting device as claimed in claim 4, wherein said accommodation chamber further comprises a flange corresponding to the gap between two distal ends of said C-shaped flange of said liquid level display.

6. The cutting device as claimed in claim 2, wherein said accommodation chamber further comprises a rim extending around a topmost edge of said upright peripheral wall; said liquid level display disposed underneath a bottom side relative to said rim.

7. The cutting device as claimed in claim 6, wherein said accommodation chamber further comprises a stop flange downwardly extended from said rim.

8. The cutting device as claimed in claim 1, wherein said through hole of said accommodation chamber is disposed adjacent to said bottom wall; and said bottom wall slopes downwardly in direction toward said through hole.

9. The cutting device as claimed in claim 1, further comprising a sensor and alarm unit, said sensor and alarm unit comprising at least one sensor adapted for sensing a level of the cooling fluid in said liquid level display corresponding to a level of the cooling fluid in said accommodation chamber, a control device electrically connected to said at least one sensor, and an audio visual alarm electrically connected to said control device.

10. The cutting device as claimed in claim 9, wherein said sensor and alarm unit comprises two sensors arranged at different elevations.

11. The cutting device as claimed in claim 10, wherein said liquid level display has a high-level marking line and a low-level marking line; and said two sensors are respectively disposed corresponding to said high-level marking line and said low-level marking line.

12. The cutting device as claimed in claim 1, wherein said cutting element is partially accommodated in said accommodation chamber.

13. The cutting device as claimed in claim 2, wherein said L-shaped tube is open at both ends.

14. The cutting device as claimed in claim 1, wherein said liquid level display has a high-level marking line and a low-level marking line.
